(19) United States
(12) Patent Application Publication
(10) Pub. No.: US 2006/0092866 A1
(43) Pub. Date: May 4, 2006

(54) Apparatus and method for processing information using wireless communication terminal

(75) Inventors: Seong-woon Kim, Yongin-si (KR); Eun-seok Choi, Anyang-si (KR); Won-chul Bang, Seongnam-si (KR); Chang-su Kim, Suwon-si (KR); Joon-kee Cho, Yongin-si (KR); Dong-yoon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/127,235

(22) Filed: May 12, 2005

(30) Foreign Application Priority Data
Nov. 2, 2004 (KR) 10-2004-0088214

(51) Int. Cl. H04B 7/00

(52) U.S. Cl. 370/310

(57) ABSTRACT

There are provided an information processing apparatus and method using a wireless communication terminal. The information processing apparatus includes: a wireless communication terminal generating displacement corresponding to its spatial movement by a user's manipulation, as pointing information, and wirelessly transmitting the pointing information; and an information processor receiving the pointing information transmitted from the wireless communication terminal, analyzing the received pointing information to extract the displacement, and moving a cursor on a screen to a location corresponding to the extracted displacement. Therefore, by using a wireless communication terminal as a spatial pointing device for an information processor and performing wireless data communication between the wireless communication terminal and the information processor using the pointing function of the spatial pointing device, it is possible to easily and conveniently perform data communication between the information processor and the wireless communication terminal and easily control the information processor using the wireless communication terminal.

### BACKGROUND OF THE INVENTION

This application claims the priority of Korean Patent Application No. 10-2004-0088214, filed on Nov. 2, 2004, in the Korean Intellectual Property Office, the disclosure of which is incorporated herein in its entirety by reference.

1. Field of the Invention

The present invention relates to a wireless communication terminal such as a cellular phone and an application thereof, and more particularly, to an information processing apparatus and method using a wireless communication terminal.

2. Description of the Related Art

Recently, most cellular phones include file storage functions as well as multimedia functions. That is, recent cellular phones can perform a file storage function using a flash memory, as well as perform multimedia functions such as a digital camera function, a camcoder function, an MP3 (MPEG layer 3) function. As such, since a wireless communication terminal such as a cellular phone has both the multimedia function and file storage function, such a wireless communication terminal needs to more frequently communicate with a computer, etc.

For example, when a user wants to download a file stored in a computer through a wireless communication terminal, the user selects the desired file, which the user wants to be downloaded, from a screen displayed on a monitor of the computer using a mouse or keyboard connected wiredly or wirelessly to the computer, and then wiredly or wirelessly downloads the selected file to the wireless communication terminal. As such, when a user wants to download a file from a computer to a wireless communication terminal or upload the file from the wireless communication terminal to the computer, the user must use a mouse or a keyboard connected wiredly or wirelessly to the computer. Such a manipulation may cause inconvenience when communicating between a computer and a wireless communication terminal.

### SUMMARY OF THE INVENTION

The present invention provides an information processing apparatus using a wireless communication terminal, capable of using the wireless communication terminal as a spatial pointing device.

The present invention also provides an information processing method using a wireless communication terminal, capable of using the wireless communication terminal as a spatial pointing device.

According to an aspect of the present invention, there is provided an information processing apparatus using a wireless communication terminal, comprising: a wireless communication terminal generating displacement corresponding to its spatial movement by a user's manipulation, as pointing information, and wirelessly transmitting the pointing information; and an information processor receiving the pointing information transmitted from the wireless communication terminal, analyzing the received pointing information to extract the displacement, and moving a cursor on a screen to a location corresponding to the extracted displacement.

According to another aspect of the present invention, there is provided an information processing method performed by an information processing apparatus including a wireless communication terminal and an information processor, comprising: generating, as pointing information, displacement corresponding to spatial movement of the wireless communication terminal by a user's manipulation; wirelessly transmitting the generated pointing information to the information processor; receiving the pointing information wirelessly transmitted from the wireless communication terminal; analyzing the received pointing information and extracting the displacement; and moving a cursor on a screen to a location corresponding to the extracted displacement.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an information processing apparatus using a wireless communication terminal, according to an embodiment of the present invention;

FIG. 2 is a flowchart illustrating an information processing method using a wireless communication terminal, according to an embodiment of the present invention;

FIG. 3 is a block diagram of the information processing apparatus shown in FIG. 1, according to an embodiment of the present invention;

FIG. 4 is a flowchart illustrating an information processing method, according to another embodiment of the present invention;

FIG. 5 is a flowchart illustrating an information processing method, according to another embodiment of the present invention;

FIG. 6 is a flowchart illustrating an information processing method, according to another embodiment of the present invention;

FIGS. 7(a) and 7(b) illustrate an example in which information is downloaded; and

FIGS. 8(a) and 8(b) illustrate an example in which information is uploaded.

### DETAILED DESCRIPTION OF THE INVENTION

Hereinafter, the configuration and operation of an information processing apparatus using a wireless communication terminal, and an information processing method performed by the apparatus, according to the present invention, will be described in detail with reference to the appended drawings.

FIG. 1 is a block diagram of an information processing apparatus using a wireless communication terminal, according to an embodiment of the present invention, wherein the information processing apparatus includes a wireless communication terminal 10 and an information processor 12.

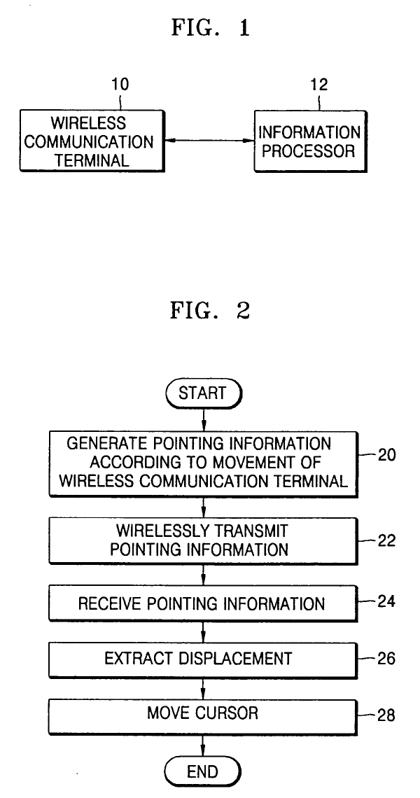

FIG. 2 is a flowchart illustrating an information processing method using a wireless communication terminal, according to an embodiment of the present invention, wherein the information processing method includes: generating pointing information in the wireless communication terminal 10 and wirelessly transmitting the pointing information to the information processor 12 (operations 20 and 22), and moving a cursor using the pointing information in the information processor 12 (operations 24 through 28).

The information processing method shown in FIG. 2 can be performed by the information processing apparatus shown in FIG. 1.

The wireless communication terminal 10 shown in FIG. 1 is moved spatially not two-dimensionally by a user, and generates, as pointing information, displacement according to its three-dimensional movement (operation 20). In general, a pointing device such as a mouse is two-dimensionally moved by a user, then generates displacement, and transmits the generated displacement to a computer, etc. However, the wireless communication terminal 10 according to the present invention is moved by a user three-dimensionally, not two-dimensionally, and then generates displacement as pointing information. After operation 20, the generated pointing information is wirelessly transmitted to the information processor 12 (operation 22). That is, according to the present invention, the wireless communication terminal 10 acts as a spatial mouse. Examples of such a spatial mouse are disclosed in U.S. Pat. No. 5,898,421 and No. 5,825,350

The wireless communication terminal 10 performs operations 20 and 22 of FIG. 2 if a user requests the information processor 12 to be used as a pointing device. Otherwise, the wireless communication terminal 10 performs general wireless communication functions. For example, the user manipulates desired keys among keys provided in the wireless communication terminal 10, thus requesting the wireless communication terminal 10 to operate as a pointing device of the information processor 12.

After operation 22, the information processor 12 receives the pointing information wirelessly transmitted from the wireless communication terminal 10 (operation 24). After operation 24, the information processor 12 analyzes the received pointing information and extracts displacement of the wireless communication terminal 10 (operation 26). After operation 26, the information processor 12 moves a cursor on a screen to a location corresponding to the extracted displacement (operation 28).

The information processor 12 shown in FIG. 1 includes a display unit (not shown) for displaying a screen showing a cursor which is moved by a pointing device, and processes various information (that is, data). For example, the information processor 12 may be a notebook computer, a desktop computer, a PDA/Handheld PC, or a digital television, etc. According to the present invention, the wireless communication terminal 10 shown in FIG. 1 acts as a pointing device for the information processor 12. For example, according to the present invention, a wireless communication terminal 10 such as a cellular phone can act as a ‘spatial’ mouse of an information processor 12 such as a personal computer, etc.

As such, to use the wireless communication terminal 10 as a pointing device of the information processor 12, the wireless communication terminal 10 should be located near the information processor 12.

Hereinafter, the configuration and operation of an information processing apparatus using a wireless communication terminal, according to an embodiment of the present invention, and an information processing method performed by the embodiment are described in detail with reference to the appended drawings.

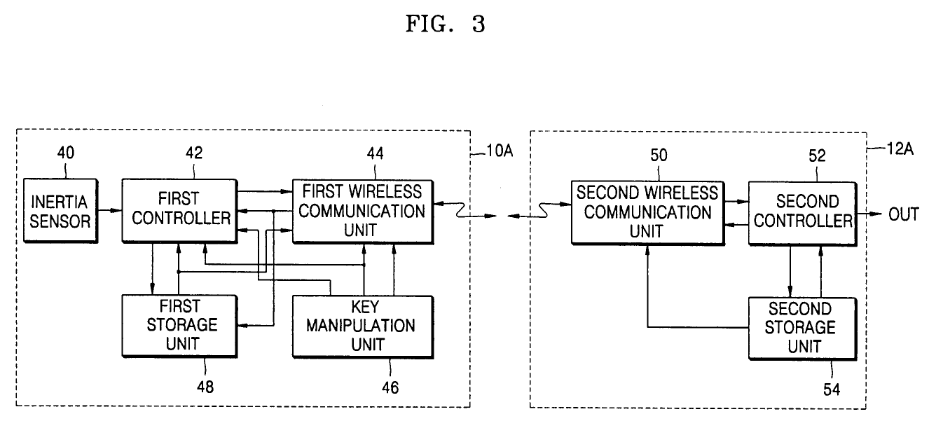

FIG. 3 is a block diagram of the information processing apparatus shown in FIG. 1, according to an embodiment of the present invention, wherein the information processing apparatus includes a wireless communication terminal 10A and an information processor 12A.

According to the present embodiment, the information processing apparatus shown in FIG. 3 can perform operations 20 through 28 shown in FIG. 2. In this case, the wireless communication terminal 10A shown in FIG. 3 includes an inertia sensor 40, a first controller 42, and a first wireless communication unit 44. The information processor 12A shown in FIG. 3 can include a second wireless communication unit 50 and a second controller 52.

The inertia sensor 40 and the first controller 42 shown in FIG. 3 perform operation 20 shown in FIG. 2. First, the inertia sensor 40 senses spatial movement of the wireless communication terminal 10A by a user and outputs the sensed result to the first controller 42. The inertia sensor 40 may be an acceleration sensor or an angular velocity sensor, etc. The first controller 42 generates displacement according to the spatial movement of the wireless communication terminal 10A, as pointing information, using the sensed result received from the inertia sensor 40, and outputs the generated pointing information to the first wireless communication unit 44.

To perform operation 22, the first wireless communication unit 44 wirelessly transmits the pointing information generated by the first controller 42 to the information processor 12A.

To perform operation 24, the second wireless communication unit 50 receives the pointing information wirelessly transmitted from the first wireless communication unit 44 and outputs the received pointing information to the second controller 52.

To perform operation 26, the second controller 52 analyzes the pointing information received from the second wireless communication unit 50 and extracts displacement. To perform operation 28, the second controller 52 outputs a cursor control signal for moving a cursor to a location corresponding to the extracted displacement through an output terminal OUT. For example, the cursor control signal output through the output terminal OUT can be output to a display unit (not shown) and to a window manager, etc. for controlling movement of the cursor. The display unit or the window manager moves the cursor to a location corresponding to the extracted displacement in response to the cursor control signal. Conventional techniques in which a window manager or display unit moves a cursor using a cursor control signal are disclosed in U.S. Pat. No. 5,898,421 and No. 5,825,350.

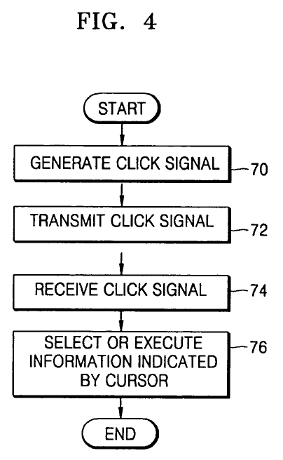

FIG. 4 is a flowchart illustrating an information processing method, according to another embodiment of the present invention, wherein the information processing method includes: generating a click signal and wirelessly transmitting the click signal (operations 70 and 72) and selecting information indicated by a cursor in response to the click signal (operations 74 and 76).

Referring to FIGS. 1 and 4, according to another embodiment of the present invention, the wireless communication terminal 10 is manipulated by a user to thereby generate a click signal (operation 70). Here, the click signal is generally the same signal as a signal transmitted from a mouse to a computer, etc. when the user clicks the mouse.

After operation 70, the wireless communication terminal 10 wirelessly transmits the generated click signal to the information processor 12 (operation 72). After operation 72, the information processor 12 receives the click signal wirelessly transmitted from the wireless communication terminal 10 (operation 74). After operation 74, the information processor 12 selects or executes information indicated by a cursor in response to the received click signal (operation 76). That is, if the information processor 12 receives the click signal transmitted from the wireless communication terminal 10, the information processor 12 selects or performs the information indicted by the cursor 12 as user's desired information.

To perform operations 70 through 76 shown in FIG. 4, the wireless communication terminal 10A shown in FIG. 3 can further include a key manipulation unit 46 as well as the inertia sensor 40, the first controller 42, and the first wireless communication unit 44. Also, the information processor 12A consists of the second wireless communication unit 50 and the second controller 52 only as described above.

To perform operation 70, the key manipulation unit 46 is manipulated by the user, generates a click signal, and outputs the generated click signal to the first wireless communication unit 44.

To perform operation 72, the first wireless communication unit 44 wirelessly transmits the click signal to the information processor 12A. To perform operation 74, the second wireless communication unit 50 receives the click signal.

To perform operation 76, the second controller 52 selects information indicated by a cursor in response to the click signal. Or, the second controller 52 can also execute information indicated by a cursor in response to the click signal. In detail, the key manipulation unit 46 corresponds to a click button of a general mouse. For example, after one among a plurality of menus displayed is pointed by a mouse, the pointed menu can be selected by once clicking a click button of the mouse and the selected menu can be performed by twice clicking (that is, double-clicking) the click button. Likewise, the second controller 52 can select information in response to a click signal generated by once manipulating the key manipulation unit 46 and can perform the information in response to a click signal generated by twice manipulating the key manipulation unit 46. As a result, the key manipulation unit 46 performs the same function as the click button of the mouse.

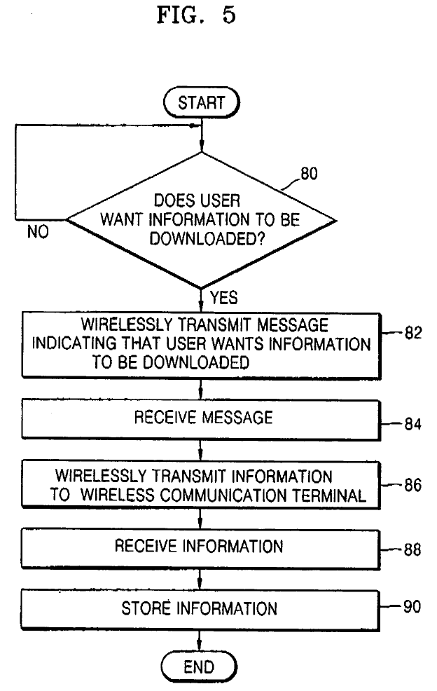

FIG. 5 is a flowchart illustrating an information processing method, according to another embodiment of the present invention, wherein the information processing method includes: downloading information from the information processor 12 to the wireless communication terminal 10 and storing the downloaded information (operations 80 through 90).

Referring to FIGS. 1 and 5, according to another embodiment of the present invention, the wireless communication terminal 10 determines whether a user wants information indicated by a cursor and selected by a click signal to be downloaded from the information processor 12 to the wireless communication terminal 10 (operation 80). If a user wants the information to be downloaded, the wireless communication terminal 10 wirelessly transmits a message indicating that the user wants information to be downloaded, to the information processor 12 (operation 82).

After operation 82, the information processor 12 receives the message transmitted from the wireless communication terminal 10 (operation 84). After operation 84, the information processor 12 wirelessly transmits the information indicated by the cursor and selected by the click signal to the wireless communication terminal 10, in response to the received message (operation 86). In the present invention, the information wirelessly transmitted from the information processor 12 to the wireless communication terminal 10 may have a format of a file.

After operation 86, the wireless communication terminal 10 receives the information transmitted from the information processor 12 (operation 88). After operation 88, the wireless communication terminal 10 stores the received information (operation 90).

To perform operations 80, 82, 88, and 90 shown in FIG. 5, the wireless communication terminal 10A is manipulated by the user to thereby generate a download request signal, wirelessly transmits the download request signal to the information processor 12A, and stores information transmitted from the information processor 12A. For that, as shown in FIG. 3, the wireless communication terminal 10A can further include a first storage unit 48 as well as the inertia sensor 40, the first controller 42, the first wireless communication unit 44, and the key manipulation unit 46.

Also, to perform operations 84 and 86 shown in FIG. 5, the information processor 12A receives the download request signal transmitted from the wireless communication terminal 10A and wirelessly transmits the information indicted by the cursor and selected by the click signal to the wireless communication terminal 10A in response to the download request signal. For that, the information processor 12A can further include a second storage unit 54 as well as the second wireless communication unit 50 and the second controller 52.

For example, to perform operation 80, the key manipulation unit 46 of the wireless communication terminal 10A is manipulated by a user to thereby generate a download request signal and outputs the generated download request signal to the first wireless communication unit 44. For example, a user, which wants information indicated by the cursor and selected by a click signal to be downloaded from the information processor 12A to the wireless communication terminal 10A, manipulates the key manipulation unit 46 to generate a download request signal.

To perform operation 82, the first wireless communication unit 44 wirelessly transmits a download request signal corresponding to a message indicating that an information download is requested to the information processor 12A.

To perform operation 84, the second wireless communication unit 50 receives the download request signal transmitted from the wireless communication terminal 10A and outputs the received download request signal to the second controller 52.

The second wireless communication unit 50, the second controller 52, and the second storage unit 54 perform operation 86. First, the second controller 52 reads information indicated by the cursor and selected by the click signal from the second storage unit 54, in response to the download request signal received from the second wireless communication unit 50, and outputs the read information to the second wireless communication unit 50. At this time, the information read from the second storage unit 54 can be provided to the second wireless communication unit 50 via the second controller 52. Or, the information read from the second storage unit 54 can be directly output from the second storage unit 54 to the second wireless communication unit 50 without passing through the second controller 52, under the control of the second controller 52. Here, the second storage unit 54 stores various information. At this time, the second wireless communication unit 50 wirelessly transmits the information read from the second storage unit 54 to the wireless communication terminal 10A.

To perform operation 88, the first wireless communication unit 44 receives the information transmitted from the information processor 12A and outputs the received information to the first controller 42.

The first controller 42 and the first storage unit 48 perform operation 90. The first controller 42 outputs information received from the first wireless communication unit 44 to the first storage unit 48, in response to a download request signal received from the key manipulation unit 46. The first storage unit 48 stores information received from the first controller 42. Here, information received by the first wireless communication unit 44 can be directly output from the first wireless communication unit 44 to the first storage unit 48 without passing through the first controller 42, under the control of the first controller 42.

In the present invention, the key manipulation unit 46 shown in FIG. 3 can be manipulated by a user to generate an information erase signal, and output the generated information erase signal to the first controller 42. Here, the first controller 42 can erase information corresponding to the information erase signal from the first storage unit 48. As such, information downloaded from the information processor 12A to the wireless communication terminal 10A can be erased by a user.

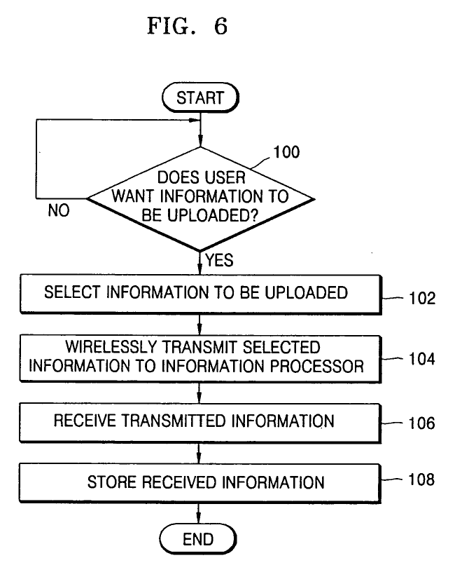

FIG. 6 is a flowchart illustrating an information processing method, according to another embodiment of the present invention, wherein the information processing method includes: uploading information from the wireless communication terminal 10 to the information processor 12 (operations 100 through 108).

According to another embodiment of the present invention, the wireless communication terminal 10 determines whether a user wants information to be uploaded from the wireless communication terminal 10 to the information processor 12 (operation 100). If it is determined that a user wants information to be uploaded from the wireless communication terminal 10 to the information processor 12, the wireless communication terminal 10 selects the information which the user wants to be uploaded among its stored information (operation 102). After operation 102, the wireless communication terminal 10 wirelessly transmits the selected information to the information processor 12 (operation 104).

After operation 104, the information processor 12 receives the information transmitted from the wireless communication terminal 10 (operation 106). After operation 106, the information processor 12 matches the received information with information selected or performed by a click signal and stores the matched result (operation 108).

For example, if the information selected or performed by the click signal is a folder, the received information can be stored in the folder.

To perform operations 100, 102, and 104 shown in FIG. 6, the wireless communication terminal 10A reads information selected by the user among the stored information and wirelessly transmits the read information to the information processor 12A in response to an upload request signal manipulated and generated by the user. For that, the wireless communication terminal 10A includes the inertia sensor 40, the first controller 42, the first wireless communication unit 44, the key manipulation unit 46, and the first storage unit 48.

Also, to perform operations 106 and 108 shown in FIG. 6, the information processor 12A receives information transmitted from the wireless communication terminal 10A, matches the received information with information selected or performed by a click signal, and stores the matched result. For that, the information processor 12A can include the second wireless communication unit 50, the second controller 52, and the second storage unit 54.

For example, to perform operation 100, the key manipulation unit 46 of the wireless communication terminal 10A is manipulated by the user to generate an upload request signal and outputs the generated upload request signal to the first wireless communication unit 44. For example, a user, which wants information indicated by a cursor to be uploaded from the wireless communication terminal 10A to the information processor 12A, manipulates the key manipulation unit 46, thus generating an upload request signal.

The first controller 42, the key manipulation unit 46, and the first storage unit 48 perform operation 102. First, the key manipulation unit 46 is manipulated by the user to generate a selection signal and outputs the generated selection signal to the first controller 42. Then, the first controller 42 reads information, which the user wants to select, from the first storage unit 48 in response to the selection signal received from the key manipulation unit 46 and transmits the selected information to the first wireless communication unit 44.

According to an embodiment of the present invention, it is possible that the first controller 42 reads information, which the user wants to select, from the first storage unit 48 in response to a selection signal, stores the read information therein, and then transmits the information to the first wireless communication unit 44.

According to another embodiment of the present invention, the first controller 42 controls the first storage unit 48 so that information read from the first storage unit 48 is directly output to the first wireless communication unit 44 instead of outputting the information to the first controller 42. Here, the first storage unit 48 stores the information.

To perform operation 104, the first wireless communication unit 44 wirelessly transmits the information read from the first storage unit 48 to the information processor 12A in response to an upload request signal received from the key manipulation unit 46.

To perform operation 106, the second wireless communication unit 50 receives the information transmitted from the wireless communication terminal 10A and outputs the received information to the second controller 52.

The second controller 52 and the second storage unit 54 perform operation 108. First, the second controller 52 matches the information received to the second wireless communication unit 50 with information selected or performed by a click signal and stores the matched result in the second storage unit 54. At this time, the second storage unit 54 stores the transmitted information.

According to the present invention, each of the first and second wireless communication units 44 and 50 shown in FIG. 3 may be a local wireless communication module such as Bluethooth, IrDA (Infrared Data Association), PIAFS (PHS Internet Access Forum Standard), SWAP (Shared Wireless Access Protocol), or wireless LAN (IEEE802.11b).

Hereinafter, for the convenience of understanding, assume that the above-described wireless communication terminal 10 or 10A corresponds to a cellular phone, the information processor 12 or 12A corresponds to a personal computer, and the key manipulation unit 46 shown in FIG. 3 corresponds to a key set of the cellular phone. In this case, the information processing apparatus and method as described above will be described with reference to the appended drawings below.

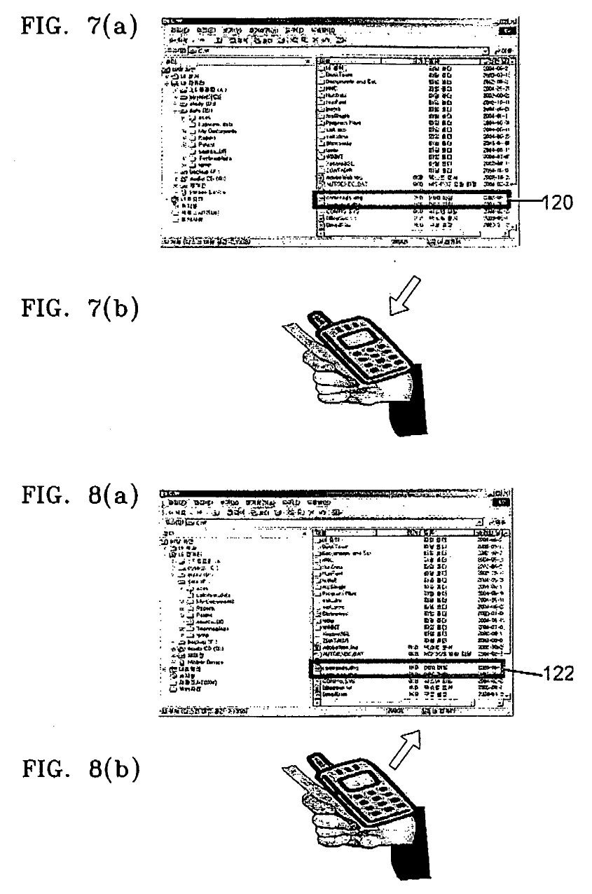

FIGS. 7(a) and 7(b) illustrate an example in which information is downloaded, wherein FIG. 7(a) shows a screen displayed on the information processor 12 or 12A and FIG. 7(b) shows a view in which a user manipulates the wireless communication terminal 10 or 10A to download information.

First, a user manipulates a first specific key of a cellular phone to request the cellular phone to operate as a pointing device of a computer. That is, by manipulating the first specific key, the cellular phone is changed from a wireless communication mode in which the cellular phone performs its intrinsic operation to a pointing device mode in which the cellular phone operates as a pointing device. For example, if a screen as shown in FIG. 7(a) is displayed on a monitor of a computer, the user indicates a desired file 120 among files shown on the screen through a cursor by spatially moving his/her cellular phone like a mouse. At this time, the user manipulates a second specific key of the cellular phone to generate a click signal. The information processor 12 or 12A selects the file indicated by the cursor in response to the click signal. Then, the user manipulates a third specific key of the cellular phone to generate a download request signal. At this time, the information processor 12 or 12A, as described above, transmits a file selected by the user to the wireless communication terminal 10 or 10A in response to the download request signal.

As such, as shown in FIG. 7(b), the user manipulates the first and second specific keys of the cellular phone and manipulates the third specific key of the cellular phone while using the cellular phone like a mouse of a computer, thereby downloading a desired file from the computer. Here, the first, second, and third specific keys can be included in the key manipulation unit 46 shown in FIG. 3. For example, the third specific key may be a volume down button provided in the cellular phone.

FIGS. 8(a) and 8(b) illustrate an example in which information is uploaded, wherein FIG. 8(a) shows a screen displayed on the information processor 12 or 12A and FIG. 8(b) shows a view in which a user manipulates the wireless communication terminal 10 or 10A to upload information.

For example, if a screen as shown in FIG. 8(a) is displayed on a monitor of a computer, the user can select a desired file 122 among files shown on the screen by manipulating the first and second specific keys of his/her cellular phone, as described above. Then, the user manipulates a fourth specific key of the cellular phone to generate an upload request signal. At this time, the wireless communication terminal 10 or 10A, as described above, transmits the file selected by the user to the information processor 12 or 12A in response the an upload request signal. When the information processor 12 or 12A stores the file transmitted from the wireless communication terminal 10 or 10A, the information processor 12 or 12A can store the file in a folder 122 of the file indicated by a cursor. For that, by double clicking of twice pressing the second specific key, opening the corresponding folder 122, and manipulating the fourth specific key, it is possible to store the uploaded file in the opened folder 122.

As such, as shown in FIG. 8(b), the user manipulates the first and second specific keys of the cellular phone to use the cellular phone like a mouse of a computer and manipulates the fourth specific key of the cellular phone to upload a file to the computer. Here, the first, second, and fourth specific keys can be included in the key manipulation unit 46 shown in FIG. 3, wherein the fourth specific key may be a volume up button provided in the cellular phone.

As described above, in an information processing apparatus and method using a wireless communication terminal, according to the present invention, by using a wireless communication terminal as a spatial pointing device for an information processor and performing wireless data communication between the wireless communication terminal and the information processor using the pointing function of the spatial pointing device, it is possible to easily and conveniently perform data communication between the information processor and the wireless communication terminal and easily control the information processor using the wireless communication terminal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An information processing apparatus using a wireless communication terminal, comprising:
a wireless communication terminal generating displacement corresponding to its spatial movement by a user's manipulation, as pointing information, and wirelessly transmitting the pointing information; and
an information processor receiving the pointing information transmitted from the wireless communication terminal, analyzing the received pointing information to extract the displacement, and moving a cursor on a screen to a location corresponding to the extracted displacement.

2. The apparatus of claim 1, wherein the wireless communication terminal comprises:
an inertia sensor sensing the spatial movement by the user and outputting the sensed result;
a first controller generating the pointing information using the sensed result output from the inertia sensor; and
a first wireless communication unit wirelessly transmitting the pointing information generated by the first controller to the information processor.

3. The apparatus of claim 2, wherein the information processor comprises:
a second wireless communication unit receiving the pointing information; and
a second controller analyzing the received pointing information to extract the displacement and moving the cursor to a location corresponding to the extracted displacement.

4. The apparatus of claim 3, wherein the wireless communication terminal is manipulated by the user, generates a click signal, and wirelessly transmits the click signal, and
the information processor receives the click signal transmitted from the wireless communication terminal and selects or executes information indicated by the cursor in response to the received click signal.

5. The apparatus of claim 4, wherein the wireless communication terminal further comprises a key manipulation unit which is manipulated by the user, generates the click signal, and outputs the generated click signal to the first wireless communication unit,
wherein the first wireless communication unit wirelessly transmits the click signal to the information processor, the second wireless communication unit receives the click signal, and the second controller selects or executes the information indicated by the cursor in response to the click signal.

6. The apparatus of claim 4, wherein the wireless communication terminal is manipulated by the user, generates a download request signal, wirelessly transmits the download request signal to the information processor, and stores information transmitted from the information processor, and
the information processor receives the download request signal transmitted from the wireless communication terminal and wirelessly transmits information indicated and selected by the cursor to the wireless communication terminal in response to the download request signal.

7. The apparatus of claim 6, wherein the information wirelessly transmitted to the wireless communication terminal has a format of a file.

8. The apparatus of claim 6, wherein the wireless communication terminal further comprises:
a key manipulation unit manipulated by the user to generate the download request signal, and outputting the generated download request signal to the first wireless communication unit; and
a first storage unit storing the information transmitted from the information processor,
wherein the first wireless communication unit transmits the download request signal to the information processor, receives the information transmitted from the information processor, and outputs the received information to the first controller, and the first controller outputs the information received from the first wireless communication unit to the first storage unit in response to the download request signal.

9. The apparatus of claim 8, wherein the key manipulation unit is manipulated by the user and generates an information erase signal, and
the first controller erases information corresponding to the information erase signal from the first storage unit.

10. The apparatus of claim 8, wherein the information processor further comprises a second storage unit storing a plurality of information,
the second wireless communication unit receives the download request signal transmitted from the wireless communication terminal and outputs the received download request signal to the second controller,
the second controller reads the information indicated and selected by the cursor from the second storage unit in response to the download request signal received from the second wireless communication unit, and outputs the read information to the second wireless communication unit, and
the second wireless communication unit wirelessly transmits the information read from the second storage unit to the wireless communication terminal.

11. The apparatus of claim 4, wherein the wireless communication terminal reads information selected by the user among stored information and wirelessly transmits the read information to the information processor in response to an upload request signal generated by manipulating the mobile communication terminal by the user, and
the information processor receives the information transmitted from the wireless communication terminal, matches the received information with information selected or performed by the click signal, and stores the matched result.

12. The apparatus of claim 11, wherein the wireless communication terminal further comprises:
a first storage unit storing a plurality of information; and
a key manipulation unit manipulated by the user to generate a selection signal and the upload request signal and outputting the generated selection signal to the first controller,
wherein the first controller reads information, which the user wants to select, from the first storage unit, in response to the selection signal, and outputs the read information to the first wireless communication unit, and
the first wireless communication unit wirelessly transmits the information read from the first storage unit to the information processor in response to the upload request signal.

13. The apparatus of claim 12, wherein the information processor further comprises a second storage unit storing the information transmitted from the wireless communication terminal,
the second wireless communication unit receives the information transmitted from the wireless communication terminal, and
the second controller matches the information received to the second wireless communication unit with information selected or performed by the click signal and storing the matched result in the second storage unit.

14. The apparatus of claim 1, wherein the information processor is a computer.

15. The apparatus of claim 1, wherein the information processor is a digital television.

16. The apparatus of claim 3, wherein the first and second wireless communication units wirelessly communicate with each other using Bluethooth.

17. An information processing method performed by an information processing apparatus including a wireless communication terminal and an information processor, comprising:
generating, as pointing information, displacement corresponding to spatial movement of the wireless communication terminal by a user's manipulation;
wirelessly transmitting the generated pointing information to the information processor;
receiving, at the information processor, the pointing information wirelessly transmitted from the wireless communication terminal;
analyzing the received pointing information and extracting the displacement; and
moving a cursor on a screen to a location corresponding to the extracted displacement.

18. The method of claim 17, further comprising:
generating a click signal by a user's manipulation in the wireless communication terminal;
wirelessly transmitting the generated click signal from the wireless communication terminal to the information processor;
receiving the click signal transmitted from the wireless communication terminal; and
selecting or performing information indicated by the cursor in response to the received click signal.

19. The method of claim 18, further comprising:
determining whether the user wants the information indicted by the cursor to be downloaded from the information processor to the wireless communication terminal;
if it is determined that the user wants the information indicted by the cursor to be downloaded from the information processor to the wireless communication terminal, wirelessly transmitting a message indicating that the user wants the information to be downloaded to the information processor;
receiving the message transmitted from the wireless communication terminal;
wirelessly transmitting information indicated and selected by the cursor to the wireless communication terminal in response to the received message; and
receiving information transmitted from the information processor; and storing the received information.

20. The method of claim 18, further comprising:
determining whether a user wants information to be uploaded from the wireless communication terminal to the information processor;
if it is determined that the user wants the information to be uploaded from the wireless communication terminal to the information processor, selecting the information, which the user wants to be uploaded, among stored information;
wirelessly transmitting the selected information to the information processor;
receiving the information transmitted from the wireless communication terminal; and
matching the received information with information selected or performed by the click signal and storing the matched result.
